(19) United States
(12) Patent Application Publication
(10) Pub. No.: US 2014/0089100 A1
(43) Pub. Date: Mar. 27, 2014

(54) METHOD FOR CONSUMER-CONTROLLED DIRECT MARKETING AND CONSUMER-CONTROLLED TARGETING OF ADVERTISING

(71) Applicant: VALO VENTURES OY, Espoo (FI)

(72) Inventors: Tuomo SIHVOLA, Espoo (FI); Tero-Markus SAARIMAA, Espoo (FI)

(73) Assignee: Valo Ventures Oy, Espoo (FI)

(21) Appl. No.: 13/628,367

(22) Filed: Sep. 27, 2012

(51) Int. Cl. G06Q 30/02

(52) U.S. Cl. CPC G06Q 30/0269
USPC 705/14.66

(57) ABSTRACT

A method of consumer-controlled direct marketing and consumer-controlled targeting of advertising comprises the steps of user storing an interest or need into the system in context of consuming web content, possibly with related additional information implicitly or explicitly, the business owner searching for potentially commercially relevant interests, and after selecting and defining the target group via user interface keeping consumers anonymous, sending personal offers based on the explicit needs directly to the users. User receives the offer and whenever desired, opens the offer for reading. Opening the offer triggers charging the business owner based on for example click, view or the value of the offer. Charging can be also based on for example call to action or percentage of the purchase value.

### TECHNICAL FIELD

The present invention relates to a method, an apparatus and a computer program product for helping consumers' interests and direct marketing to match under consumer control.

### BACKGROUND

Currently targeted marketing in web is far from optimal because from consumers' perspective it often occurs in irrelevant context and is often based on very weak targeting or no targeting at all. Whole process starts from and is run by advertisers shouting their messages that are mainly considered irrelevant or not perceived at all by consumers.

For advertiser, direct marketing is often inefficient and expensive. Poor marketing/spamming can even damage the brand. For small local businesses specifically it's often also very challenging to get customer attention to marketing messages in Internet since search and advertising in services are dominated by big money paid advertising by big brands and online shops.

From consumers' perspective, there's no “neutral” way to store possible commercial interests based on context of own behaviour in web. Instead, existing ways to store interests are either separate solutions (applications or services) or solutions restricted to certain commercial stakeholders or service providers (such as Amazon's “Wishlist”).

Problem related to the separate applications or services is that they are out of context of the natural and regular use of consuming web content. That's why they don't attract large number of users to regularly mark and store their interests. Problem related to the commercial stakeholder specific solutions is that user is not having the full control over own data related to the purchasing intentions, including freedom to consider variety of alternative providers. Often is of the interest of commercial stakeholder to maximise the commercial utilisation of consumers' data, which is often not the interest of the consumer.

In general, user's experience of consuming web content on certain topic may be very fragmented, i.e. using several pages, services, social media, reader applications, service provider specific sites etc. In addition, consuming more and more happens with several kinds of devices such as desktop, tablets, mobile phones. So there's no evident context nor platform to initiate storing commercial interests form user's perspective.

Essential problem is that process of digital direct marketing and targeted advertising is not resembling and supporting the real-world process of maturing the initial idea or need to purchasing decision.

In summary, there are several problems related to current situation on digital direct marketing and targeted advertising based on consumers interests and needs. At least the following problems are listed as an example: 1) consumers don't have an evident context nor platform to store all personal interests, 2) consumers can't control their profile of interests and how they are advertised to, 3) consumers can't anonymously indicate specific needs ‘democratically’ addressed by businesses, 4) businesses rarely can access specific needs with explicit permission to advertise based on the need. Many of these problems currently have specific solutions, but they are not effective without whole end-to-end support of the process.

### SUMMARY

An objective of the invention can, for example, be to implement the solution for consumer-controlled direct marketing and targeting of advertising covering the whole process from storing consumer's real interests to receiving offers based on the interests in question.

According to an aspect of the invention, there is provided a method, comprising:

receiving an interest data item for explicitly submitting customised data content to provide a digital offer of an item to a consumer of a device;

storing the interest data item;

searching for interest data items to have a search result of interest data items;

creating the digital offer comprising explicit customised data content for said item based on the search result;

sending the digital offer directly to the device of the consumer so that the consumer remains anonymous;

receiving an action of the consumer based on the digital offer; and

registering the action.

According to another aspect of the invention, there is provided a method, comprising:

defining an interest data item for explicitly receiving customised data content to receive a digital offer of an item to a consumer of a device;

sending the interest data item;

receiving the digital offer directly at the device of the consumer so that the consumer remains anonymous;

entering an action based on the digital offer; and

sending the action.

According to another aspect of the invention, there is provided an apparatus, wherein the apparatus comprises modules configured to:

receive an interest data item for explicitly submitting customised data content to provide a digital offer of an item to a consumer of a device;

store the interest data item;

search for interest data items to have a search result of interest data items;

creating the digital offer comprising explicit customised internet content for said item based on the search result;

send the digital offer directly to the device of the consumer so that the consumer remains anonymous;

receive an action of the consumer based on the digital offer; and

register the action.

An embodiment of the present invention comprises a service having web interfaces for both consumers, businesses and partners.

Embodiments of the present invention for supporting direct marketing and targeted advertising would involve several improvements compared to known situation: 1) consumers should be able to store own interests in the context of web content consumption, 2) consumers should be able to own and control the information related to their interests, 3) consumers should be able to explicitly indicate what they are looking for to be addressed in a relevant manner by advertisers, 4) consumers should be able to remain anonymous but still receive advertising only form reliable businesses. 5) Businesses should be able to know and understand what consumers are really looking for and they should be able to 6) as reliable sources send relevant advertising to consumers based on their real interests, needs and explicit allowance.

### BRIEF DESCRIPTION OF THE DRAWINGS

Having thus described the invention in general terms, reference will now be made to the accompanying drawings, which are not necessarily drawn to scale, and wherein:

FIG. 1 shows schematically a block diagram of the solution in the high level to one embodiment of the present invention.

FIG. 2 shows schematically a flow diagram of the solution to one embodiment of the present invention.

FIG. 3 illustrates user updating and refreshing an interest.

FIG. 4 illustrates consumer devices in a process how the embodiment of the invention can be implemented.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

An embodiment of the present invention comprises a service having web interfaces for consumers, businesses and partners.

For consumers, an embodiment of the present invention is about controlling own profile information related to commercial interests and intentions of buying, in order to receive relevant targeted offers.

Service can be used without registering in an embodiment of the present invention. For consumers, registering makes it possible to backup (save) personalisation information at service side databases and this also enables consumers to have the same personalisation available in multiple platforms, devices and Internet browsers. In an embodiment of the present invention, businesses can search for interests without registering, but registration and verification are needed to send offers.

For consumers the service is an advertising free content consuming, sharing and remembering service aggregating web content sources as a personalised reading experience. Triggered by a consuming experience, or independently, consumers can store any items they are interested in within the system. Consumer has a full control over storage of own interests and information related to those. Consumer can attach relevant information to the need (product, brand, model, price, time-span of purchasing, price limits, location etc.) and such information can be derived implicitly by the system (timestamp, usage history and profile related to both content consumption side and commercial side, estimate maturity of the purchasing intent etc.). Consumer can explicitly toggle certain need and related information as public one so that it can be found and addressed by businesses, while remaining anonymous.

System notifies consumer when new offer is received. Consumer opens an offer view where titles of received offers can be seen. Consumer opens a specific offer by clicking the title, which also triggers charging the business owner based on for example click, view or the value of the offer. Charging can be also based on for example call to action or percentage of the purchase value.

For businesses, an embodiment of the present invention is about having tools to utilize the consumer controlled information to improve the relevancy and hence value of direct contacts.

For businesses the service is a tool to search for potentially commercially relevant contacts to be addressed by direct contacting. Businesses can search for suitable interests with relevant criteria, but information about the consumer are never revealed to them.

Business owner can send a personalised offer to a relevant consumer or target group via the system while users remain anonymous. As senders are validated as business owners within the system, they appear as reliable advertisers for consumers.

In an embodiment of the present invention, there is a mechanism available for the consumer to block or ban possible irrelevant advertisers. In an embodiment of the present invention, there is a mechanism available for the consumer to inform service about inappropriately behaving business or inappropriate content.

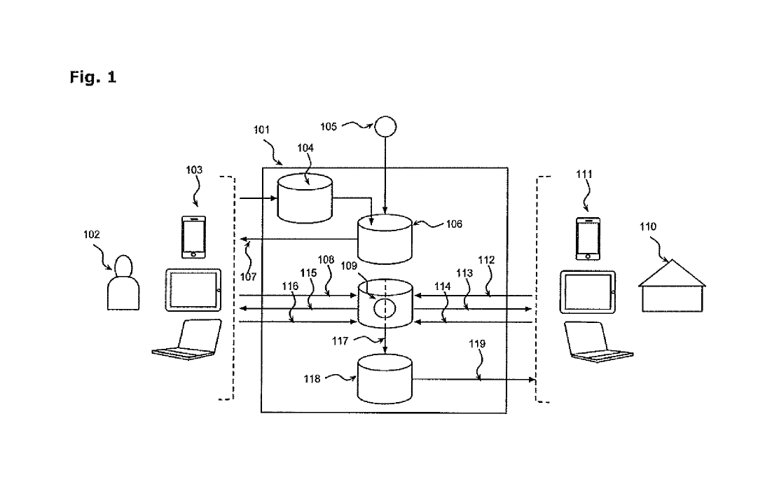

FIG. 1 illustrates an example of the main elements in a service solution described in an embodiment of the present invention. Consumers 102 can connect to the Internet service 101 with, for example, terminals 103. Consumer 102 may be also referred to as users of the terminals 103. Consumers 102 can use terminals 103 to configure 104 Internet service 101 to get content 106 they want from Internet 105 and provide it 107 to consumer's terminals 103. Terminals 103 can be a dive that is able to prove an access to Internet such as a mobile phone, lap top, a computer, screen or touch pad etc.

Consumer 102 can point and send 108 items from received content 107 in terminals 103 to be stored 109 in the Internet service 101. Consumer 102 can define stored items 109 to be visible to anyone using the Internet service 101.

Business 110, using for example terminals 111, wanting to sell items or services, can search 112 published items 109 from service 101. Service 101 will return matching items 113. Business can then select items from matching items 113 and target 114, for example, marketing messages, offers, coupons etc. 115 to consumers' 102 interests 109. Consumers 102 receive marketing messages 115 sent by the business 110 in their terminals 103. When consumer 102 opens the marketing message 115 from a business 110, service 101 will register 117 the event 116. Business can be charged 119 then accordingly.

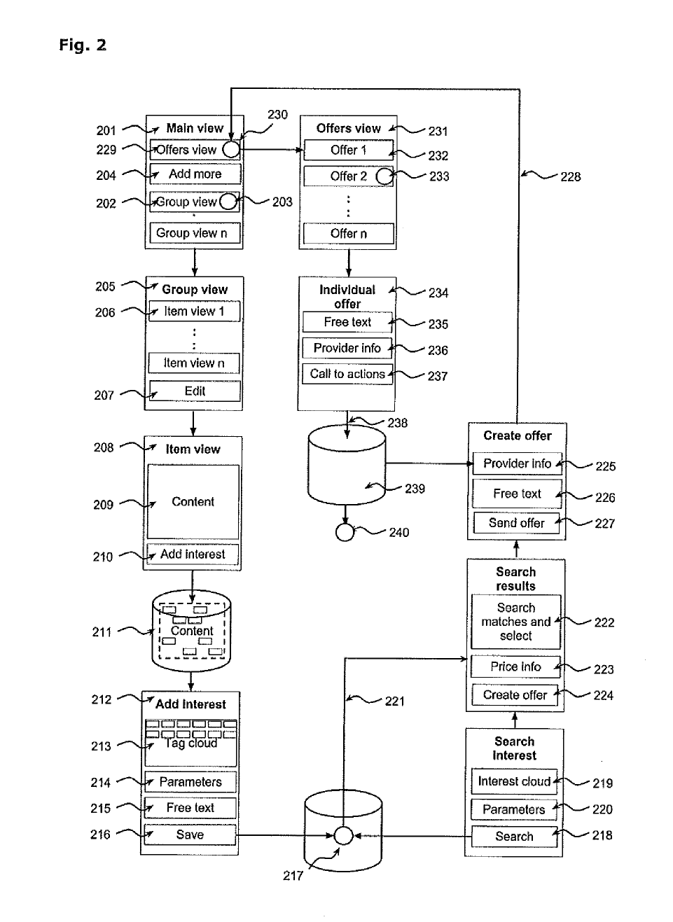

FIG. 2 illustrates an embodiment of the flow in a service solution. Consumer's main view 201 of the service comprises fully consumer selectable 204 set of group view links 202 to group views 205. In an embodiment, consumer selectable group view links 202 may include an indicator 203 indicating how many new items has been delivered by the service into a group view 205 in question since consumer last opened the group view in question.

Group view 205 comprises title and item view links 206 to open item view 208. Consumer can freely edit 207 the parameters of each group view. Consumer can give a name to each group view 205.

Item view 208 comprises title and content in form of text, hypertext, pictures, videos, sounds, music, location info or any combination of these. Item view 208 enables consumer to add 210 a personal interest from the item view 208 to the service.

Add interest functionality 210 in item view 208 opens add interest view 212. Automatic generation for the item view 208 can be an option in an embodiment of the invention. For this service may automatically generate 211 set of consumer selectable words or hyperlinks from content 209 and item view 208 text in form of for example tag cloud 213. Service may use various techniques for automatically generating 211 tag cloud 213, one example being matching words in the content and title to different ontologies.

Furthermore consumer can select one or multiple words or hyperlinks from tag cloud 212, or none. Consumer can set further parameters 214 to add interest. Parameters 214 can be for example privacy level of the interest (public, private, for friends in a specific service, etc.), maturity of interests (for example speculating, looking for help to decide, seriously interested in buying, etc.), validity of interest (for example for how long consumer's interest is valid, how large quantities consumer is interested in), location or locations (for example is consumer's interest limited to certain location or locations or not), price or price level, quality (for example new, used, antique, etc.), etc. Consumer can add more information in form of free text 215. This free text 215 can also be used alone as definition of an interest. By saving the interest 216 consumer stores the interest 212 to the service.

Consumer can also access add interest 212 directly in the service, independently of main view 201, group view 205 or item view 208. In this case consumer can use parameters 214 and free text 215 to define the interest 212.

Consumer can add interest 212 into the service, independently of main view 201, group view 205 or item view 208 with for example Internet browser plug-ins or by email or by messaging (for example SMS, MMS or Chat). In this case consumer can use parameters 214 and free text 215 to define the interest 212.

When consumer saves interest 216, an interest item 217 is created to service's databases. Consumer can set privacy in parameters 214 for the interest 212 to public. Interest 217 in database with privacy set to public can be searched 218 by businesses 110 or also by anyone using the service. Service does not reveal any consumer identity details in search 218 or in search results 222.

Businesses 110 can further define search 218 parameters 220. These parameters 220 may include for example maturity of interests (for example speculating, looking for help to decide, seriously interested in buying, etc.), validity of interest (for example for how long interest is valid, in how large quantities consumer is interested in), location or locations (for example interests limited to certain location or locations), price or price level, quality (for example new, used, antique, etc.), etc.

Businesses 110 can also search 218 based on interest cloud 219 which displays set of published interests 217. Interest cloud 219 maybe sorted and displayed for example based on interest or interest type, maturity of interests (for example speculating, looking for help to device, seriously interested in buying, etc.), validity of interest (for example for how long interest is valid, in how large quantities), location or locations (for example interests limited to certain location or locations), price or price level, quality (for example new, used, antique, etc.), etc.

Service returns 221 list of interest matching 222 the search 218. Service does not reveal any consumer identity details in search matches 222. Businesses can view the matching interests 222. Businesses 110 can select any quantity of matching interests 222 and see the price 223 of targeting a message 228 to those selected matching interests 222. Businesses 110 can refine the search 218 and/or the selection of matching interest 222, and see the effect on the price of addressing the selected interests 228.

Businesses 110 can create 224 an offer to selected matching interests 222. Offer can comprise businesses provider info 225 verified by the service 239 with for example business address, location, area of business, email address, phone number, Twitter account, etc. all verified by the service. Business can include free text 226 into the offer 228 and then send 227 the offer 228 to selected matching interest.

Consumer's main view 201 has an offer view link 229 to offers view 231. Offer view link 229 can include an indicator 230 indicating how many new offers has been delivered by the service to consumer since consumer last opened the offers view 231. Offers view 231 includes offers 228 delivered by the service to the consumer.

Consumer can open offers view 231 from for example main view's 201 offers view 229 link or from other navigational elements in the service or from other services accessing databases of the service described in this invention. When all offers 232 are viewed in offers view 231 or consumer marks them as read, number of new offers indicator 230 in offers view link 229 is reset or removed.

Offers view 231 consists of links 232 to individual offers 234. Links to individual offer 232 can have an indicator 233 indicating a new offer i.e. an offer consumer has not opened yet. By opening offer link 232, a view to individual offer 234 is opened. This also removes or resets new offer indicator 233.

Individual offer view 234 can consist of for example free text 235 from business 226, business provider info 236 with for example business address, location, area of business, email address, phone number, Twitter account, etc. all verified by the service 225, and call to actions 237 for the consumer. Call to actions 237 include for example email to business, call the business, tweet the business, reserve, get coupon, buy, delete offer, block the business for sending more offers to me, report spam, etc.

When consumer 102 opens an offer 234, service can gather information 238 of the events to it's databases 239. Service can charge 240 business which sent the offer based on for example view, value of the offer, call to action or percentage of the purchase value for example directly, in billing intervals or flat rate.

In an embodiment of the present invention, gathered history information 238 can be utilized as additional parameters when refining the targeting later on, based on how the selected consumers have reacted to the previous offers from the business owner in question.

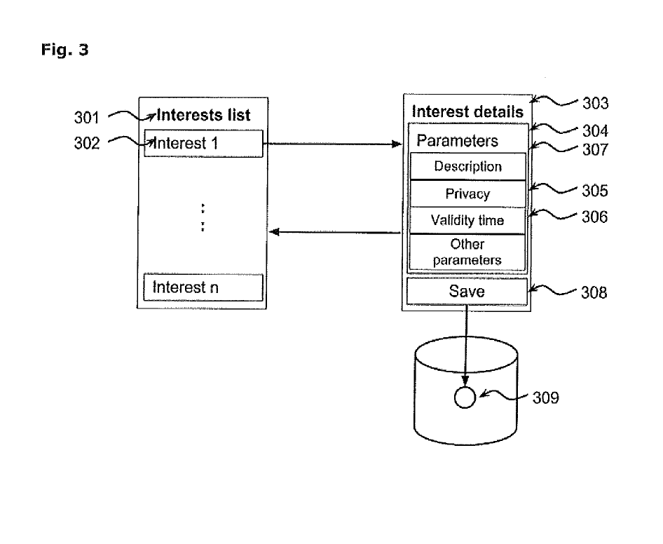

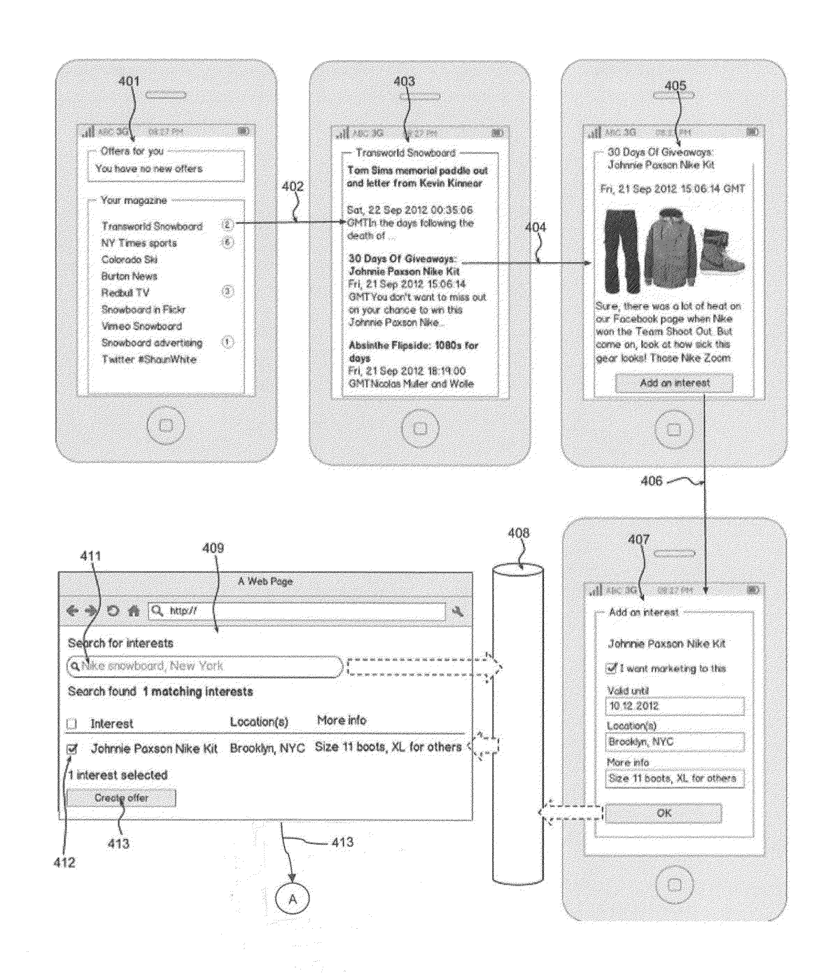

FIG. 3 illustrates user updating and refreshing own interests stored into system 216. Consumer's interests list view 301 comprises summaries 302 of the interests stored into the system with relevant attributes by user. Interest summary 302 contains at least title of the interest and may contain for example indication of validity period of the interest and indication showing whether the interest is public and can be seen by businesses. Additionally, user may be able to group own interests under multiple lists or the system can create and maintain multiple lists according to the type and parameters of interests.

Selecting an interest summary 302 opens a detailed interest view 303 where all the information and parameters 304 related to the interest are shown and where they can be edited 307 by user and saved 308 into system 309. When user saves a modified interest into the system, the updated information is available when businesses perform searches 218 to the system.

One of the attributes of an interest is the privacy setting 305 which explicitly defines if the interest is private one that can only seen by user himself or public one that can be seen by businesses or anyone performing a search 218 to the system. User can anytime toggle the privacy setting 305 between private and public and the updated setting will become immediately effective.

One of the attributes of an interest is validity time 306 which basically is a date until when the interest is valid according by user. At least every interest that has privacy set as public needs to have a validity time defined as a parameter. By looking at validity times, as shown in context of search results 222, businesses can be sure interests are still valid and are not sending offers to interests that might be outdated. When creating a new interest, a default value (e.g. 4 weeks) can be used to associate a validity period into the interest. User can freely change this parameter when creating the new interest to describe the real validity period. Later on user can refresh the validity time 306 to explicitly indicate that the interest in question will still be valid. System can indicate user when an interest is about to change as “not valid” at the end of validity period and can propose user to refresh the interest if relevant. This way businesses can consider refreshed interests as relevant ones. This mechanism prevents outdated interests showing up in the system and hence maintains the interests base relevant.

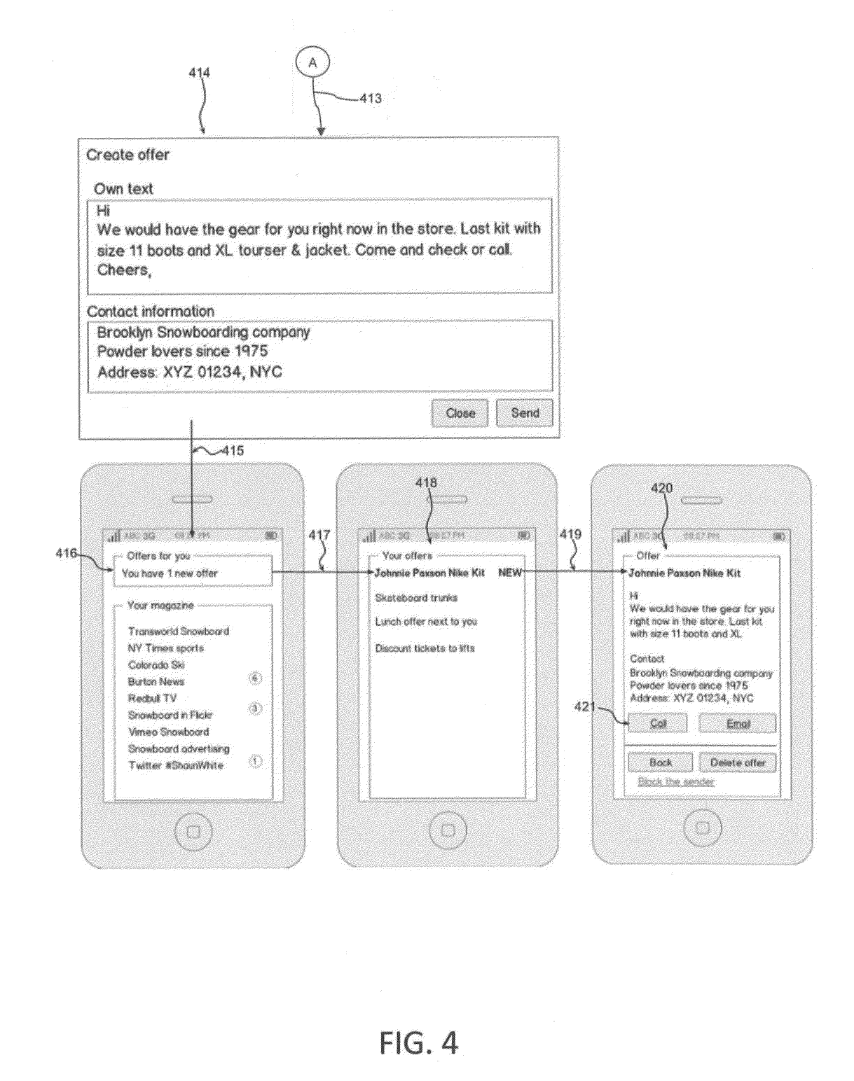

Referring to FIG. 4, consumer device is shown illustrating an example of the embodied invention. Furthermore FIG. 4 shows an interface for business to search the interest data items, as shown by web interface, for example a web page. Consumers' main view 401 indicates no new offers. Consumer looks main view 403 and sees that group view 403 named “Transworld Snowboard” has two new items. Consumer opens 402 group view 403 and browses through items in the group view 403. Consumer opens 404 item view 405 with title “30 Days Of Giveaways: Johnnie Pardon Nike Kit”. Consumer is interested in the item(s) and decides to add interest 406 into the service. Consumer further defines 407 the interest for example setting the validity time, location and some more info for example size, and allows direct marketing to this interest.

Interest is made public in the service 408—consumer stays anonymous, only interest is public.

Business use service's search 409 to search 411 for public interests 408 they could direct market their services or products. Service returns 412 matching interest(s) to the search 411. Business checks out the details 412, selects interest and starts creating 413 direct marketing message. Business writes the direct marketing message's body text 414, service includes verified contact information. Business sends 415 the direct marketing message to chosen interest.

Consumer notifies that one new offer has arrived 416. Consumer opens 417 offer view 418 and sees new direct marketing message. Consumer opens 419 new direct marketing message 420. Consumer has variety call to actions 421 available.

Service can charge the business from for example when consumer opens 419 the direct marketing message, or when user acts on various call to actions 412 (call, email, purchase, etc.)

Embodiments of the FIGS. 1, 2, 3 and 4 may be implemented by means of hardware or software or a combination of these. A computer program product comprising computer program code may be configured to perform any of the operations described with respect to FIGS. 1, 2 and 3. An apparatus having modules can be configured to perform any of the operations described with respect to FIGS. 1, 2 and 3.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method, comprising:
receiving an interest data item for explicitly submitting customised data content to provide a digital offer of an item to a device of a consumer;
storing the interest data item;
searching for interest data items to have a search result of interest data items;
creating the digital offer comprising the explicit customised data content for said item based on the search result;
sending the digital offer directly to the device of the consumer so that the consumer remains anonymous;
receiving an action of the consumer based on the digital offer; and
registering the action.

2. The method according to claim 1, wherein the interest data item comprises text defining the interest of the consumer.

3. The method according to claim 1, wherein the interest data item comprises tags, keyword or content tags defining the interest of the consumer.

4. The method according to claim 1, wherein the interest data item comprises parameters for defining privacy level of the interest, validity of the interest or a location of the interest.

5. The method according to claim 1, wherein searching and creating the digital offer does not reveal an identity of the consumer of the device.

6. The method according to claim 1, wherein the digital offer is only configured to be sent to the device of the consumer.

7. The method according to claim 1, wherein the action comprises an indication to purchase the item, an indication of viewing the digital offer, or an indication of receiving the digital offer.

8. An apparatus, wherein the apparatus comprises modules configured to:
receive an interest data item for explicitly submitting customised data content to provide a digital offer of an item to a device of a consumer;
store the interest data item;
search for interest data items to have a search result of interest data items;
creating the digital offer comprising explicit customised data content for said item based on the search result;
send the digital offer directly to the device of the consumer so that the consumer remains anonymous;
receive an action of the consumer based on the digital offer; and
register the action.

9. A method, comprising:
defining an interest data item for explicitly receiving customised data content to receive a digital offer of an item to a device of a consumer;
sending the interest data item;
receiving the digital offer directly at the device of the consumer so that the consumer remains anonymous;
entering an action based on the digital offer; and
sending the action.

10. The method according to claim 9, further comprising outputting a view comprising an internet content and an indicator how many new interest data items has been delivered to the device.

11. The method according to claim 9, further comprising outputting a view comprising an internet content and said digital offer.

12. The method according to claim 9, further comprising outputting a view comprising all digital offers delivered to the device.
